(19) United States
(12) Patent Application Publication
(10) Pub. No.: US 2008/0319480 A1
(43) Pub. Date: Dec. 25, 2008

(54) PACIFIER ACCOMMODATION DEVICE

(76) Inventor: Jacob P. Schwarz, Nashville, TN (US)

Correspondence Address: STRATEGIC PATENTS P.C.., C/O PORTFOLIOIP, P.O. BOX 52050, MINNEAPOLIS, MN, 55402, US

(21) Appl. No.: 11/841,197

(22) Filed: Aug. 20, 2007

Related U.S. Application Data
(60) Provisional application No. 60/945,385, filed on Jun. 21, 2007.

(51) Int. Cl. A61J 17/00

(52) U.S. Cl. 606/234

(57) ABSTRACT

In embodiments of the present invention, improved capabilities are described for a pacifier accommodation device. The pacifier accommodation device may be comprised of a protrusion adapted to be placed inside an infants mouth; a platform wherein the protrusion is attached; a resilient side member, wherein the member is attached to the platform; and an earpiece attached to the side member, wherein the earpiece is adapted to secure the resilient side member to an infant's ear.

### CROSS-REFERENCE TO RELATED APPLICATIONS

This application claims the benefit of the following provisional application, which is hereby incorporated by reference in its entirety: U.S. Provisional Application No. 60/945,385, filed Jun. 21, 2007.

### BACKGROUND

1. Field

The invention herein disclosed generally relates to a pacifier holder or harness, specifically to such holders that secure to the ear by way of a resilient side member.

2. Description of the Related Art

The present invention, disclosed herein, provides for a safe way for caretakers to safely secure a child's pacifier to prevent the pacifier from inadvertently falling out of the child's mouth.

### SUMMARY

Provided herein is an improved pacifier accommodation device. The pacifier accommodation device is comprised of a protrusion adapted to be placed inside an infants mouth; a platform wherein the protrusion is attached; a resilient side member, wherein the member is attached to the platform; and an earpiece attached to the side member, wherein the earpiece is adapted to secure the resilient side member to an infant's ear. In embodiments, the protrusion may be malleable.

In embodiments, the resilient side member attachment to the platform may form a flexible attachment, where the resilient side member attachment to the platform may be disconnected. The resilient side member may form a flexible attachment to the platform, where the platform may be substantially resilient. The resilient side member and the platform may form as a single assembly, where the single assembly may be injection molded. In embodiments, the earpiece and the resilient side member may form a single assembly, where the earpiece attachment to the side member may be disconnected. In embodiments, the earpiece, resilient side member, and platform may form a single assembly.

In embodiments the earpiece may have a structure, where the structure may be resilient, flexible, semi flexible, and the like. In embodiments, the structure of the earpiece may be injected molded, insulator-coated wire, or the like. In embodiments, the earpiece may be adapted to secure around the outer ear, where around the outer ear may start from above the outer ear, below the outer ear, a loop around the outer ear, or the like. In embodiments, the earpiece may be adapted to secure in proximity of the ear canal, where in proximity of the outer ear is directly outside the ear canal, directly inside the ear canal, both inside and outside the ear canal, or the like. In embodiments, the earpiece may be adapted to secure both around the outer ear and in proximity of the ear canal. In an embodiment, the side member may be resizable.

In an aspect of the invention, a pacifier retainer for retaining a child's pacifier in the child's mouth may comprise a resilient side member shaped to extend from the pacifier platform to the ear of the child. In an embodiment, the resilient side member may comprise a spring-loaded bow that conforms the device to the size of the child's head. In an embodiment, the resilient side member attachment to the platform may form a flexible attachment. In an embodiment, the resilient side member attachment to the platform may be disconnected. In an embodiment, the platform may be substantially resilient. In an embodiment, the resilient side member and the platform may be formed as a single assembly. In an embodiment, the single assembly may be injection molded. In an embodiment, the pacifier retainer further comprises an earpiece attached to the resilient side member for attachment to the child's ear. In an embodiment, the earpiece and the resilient side member may be formed as a single assembly. In an embodiment, the earpiece attachment to the side member may be disconnected. In an embodiment, the earpiece, the resilient side member, and the platform may be formed as a single assembly. In an embodiment, the earpiece may be resilient. In an embodiment, the earpiece may be injected molded. In an embodiment, the earpiece may be flexible. In an embodiment, the earpiece may be insulator-coated wire. In an embodiment, the earpiece may be adapted to secure around the outer ear. In an embodiment, the earpiece may be adapted to secure around the top of the outer ear. In an embodiment, the earpiece may be adapted to secure around the bottom of the outer ear. In an embodiment, the earpiece may be adapted to secure in proximity of the ear canal. In an embodiment, the earpiece may be adapted to secure directly outside the ear canal. In an embodiment, the earpiece may be adapted to secure directly inside the ear canal. In an embodiment, the earpiece may be adapted to secure both around the outer ear and in proximity of the ear canal. In an embodiment, the side member may be resizable.

These and other systems, methods, objects, features, and advantages of the present invention will be apparent to those skilled in the art from the following detailed description of the preferred embodiment and the drawings. All documents mentioned herein are hereby incorporated in their entirety by reference.

### BRIEF DESCRIPTION OF THE FIGURES

The invention and the following detailed description of certain embodiments thereof may be understood by reference to the following figures:

FIG. 1 depicts the invention placed in a child's mouth, and secured around one ear. The invention is shown with the platform and resilient side member as a single assembly, and as separate assemblies.

FIG. 2 depicts the invention placed in a child's mouth, and secured around both ears. The invention is shown with the platform and resilient side member as a single assembly, and as separate assemblies.

FIG. 3 depicts the invention's earpiece, secured from around the bottom of the outer ear, and separately to the proximity of the ear canal. The invention is shown with the platform and resilient side member as a single assembly, and as separate assemblies.

FIG. 4 depicts the invention's earpiece, secured from around the bottom of the outer ear. The invention is shown with the platform and resilient side member as a single assembly, and as separate assemblies.

FIG. 5 depicts the invention's earpiece, secured from around the top of the outer ear, and separately to the proximity of the ear canal. The invention is shown with the platform and resilient side member as a single assembly, and as separate assemblies.

FIG. 6 depicts the invention's earpiece, secured to the proximity of the ear canal. The invention is shown with the platform and resilient side member as a single assembly, and as separate assemblies.

FIG. 7 depicts the invention's earpiece, secured from around the bottom of the outer ear, and then around the top of the outer ear to the proximity of the ear canal. The invention is shown with the platform and resilient side member as a single assembly, and as separate assemblies.

### DETAILED DESCRIPTION

The present invention may be an improved pacifier accommodation that helps safely and passively secure a pacifier in the mouth of a child. The present invention may be safe for use with a sleeping child, especially during those times when the child may be transitioning to sleep. Although the invention, as disclosed herein, uses the example of a child transitioning to sleep in embodiments, it should be understood that this is meant to illustrate the safety of the invention, and is not meant to constrain the use of the invention to sleeping children. The present invention may be safe enough for a sleeping child, and may also be ideal for the child that is awake, where keeping a pacifier from dropping to an unclean surface may be a priority. In embodiments, the priority may be to passively keep the pacifier in the mouth of the child during the child's transition to sleep, thereby eliminating the discontinuous event of a child's pacifier falling out premature to achieving full sleep, and thereby disrupting the child's transition to sleep and causing increased agitation to the child and to the parent, and extending the time it takes the parent to put the child to sleep. The present invention, disclosed herein, may provide for a safe way for parents to secure the child's pacifier during the child's transition to sleep.

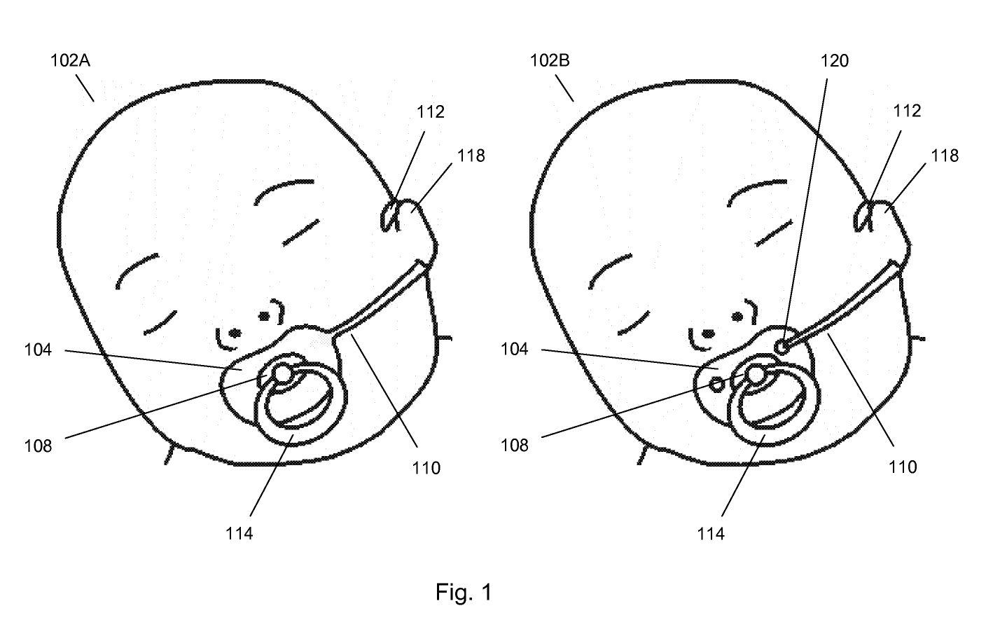

FIG. 1 shows the present invention placed in a child's 102A-B mouth, and secured around one ear 118. The present invention may be described in association with several functional portions of the invention: the platform 104, the pacifier's nippled protrusion 108, the resilient side member 110, and the earpiece 112. In embodiments, the protrusion 108 may be inserted through, and supported by, the platform 104. In embodiments, the combination of the protrusion 108 and the platform 104 may serve the same function as a typical pacifier, which also may include a ring 114 attached to the platform 104 or to the protrusion 108. The resilient side member 110 may be attached to the platform 104 at one end, and attached to the earpiece 112 at the other end. The earpiece 112 may serve to passively secure the invention to the child's 102A-B ear 118. The earpiece 112 may be passively secured to the child's 102A-B ear 118 in a plurality of ways. FIG. 1 illustrates one embodiment of the invention's attachment to the ear 118, where the earpiece 112 is shown wrapping around and behind the ear 118 from below. Other embodiments of the earpiece's 112 attachment to the ear are described herein.

In embodiments, the invention may be a single assembly, or a combination of connected subassemblies. For example, FIG. 1 shows a child 102B with the invention secured, where the resilient side member 110 and platform 104 are separate subassemblies. In this embodiment, these separate subassemblies may be connected together at a side opening 120 in the platform 104. In this embodiment, the subassembly, including the platform 104 and protrusion 108, may be a component of the present invention, or may be an off-the-shelf pacifier. The invention may accommodate the use of a platform 104 and protrusion 108 subassembly that may be integral to the invention, or use of an off-the-shelf pacifier that may attach to the resilient side member 110 of the invention. It may be understood by one of skill in the art that many different combinations of subassemblies may be accommodated by the invention, such as a separate protrusion 108 and platform 104, or a separate earpiece that connects to the resilient side member 110, or the like. In embodiments, the entire invention may be constructed as a single assembly; for example, FIG. 1 shows a child 102A with the invention as a single assembly. In any event, the side member 110 may be modified or re-sized to fit the child's mouth to ear distance. For example, the side member 110 may be cut to appropriately fit a child's mouth to ear proportions. In another embodiment, the side member 110 may be resized. For example, the side member 110 may be constructed from two pieces that slide within one another to elongate or shorten the side member 110 length. Once a correct size is slidably selected, the side member 110 may be secured with a hook and eye latch, peg and hole, clasp, buckle, or other type of securing device. Resizing may also be accomplished by removing a segment of the side member.

In embodiments, the invention may be flexible, semi-flexible, rigid, or the like. For example, the resilient side member 110 attachment to the platform 104 may form a flexible attachment, the resilient side member 110 attachment to the earpiece 112 may form a flexible attachment, the protrusion 108 attachment to the platform 104 may form a flexible attachment, and the like. In embodiments, the various parts of the invention may be flexible, such as a flexible protrusion 108, a flexible platform 104, a flexible earpiece 112, a flexible side member 110, or the like. In embodiments, the various parts of the invention may be rigid, such as a rigid protrusion 108, a rigid platform 104, a rigid earpiece 112, a rigid side member 110, or the like.

In an embodiment, the side member 110 may comprise a material with spring tension. For example, the side member 110 may be constructed with an integrated spring. In other embodiments, the material may exhibit spring tension. For example, having spring tension in the side member 110 may cause the side member 110 to be bowed out from the head. This bowing may both hold the pacifier end in the infant's mouth and compensate for different distances from mouth to ear.

In embodiments, the invention may include component parts that connect and disconnect to vary the configuration of the invention. For instance, the protrusion 108, platform 104, resilient side member 110, or earpiece 112, may be replaceable. In embodiments, a component part of the invention may be exchanged for another similarly functioning part, but with a different configuration. For example, a resilient side member 110 of different length may be exchanged in the invention to accommodate the needs of a specific child 102, differently configured earpieces 112 may be exchanged in order to customize the fit to the child's ear 118, differently configured protrusions 108 may be exchanged to accommodate the child's 102 preference, and the like.

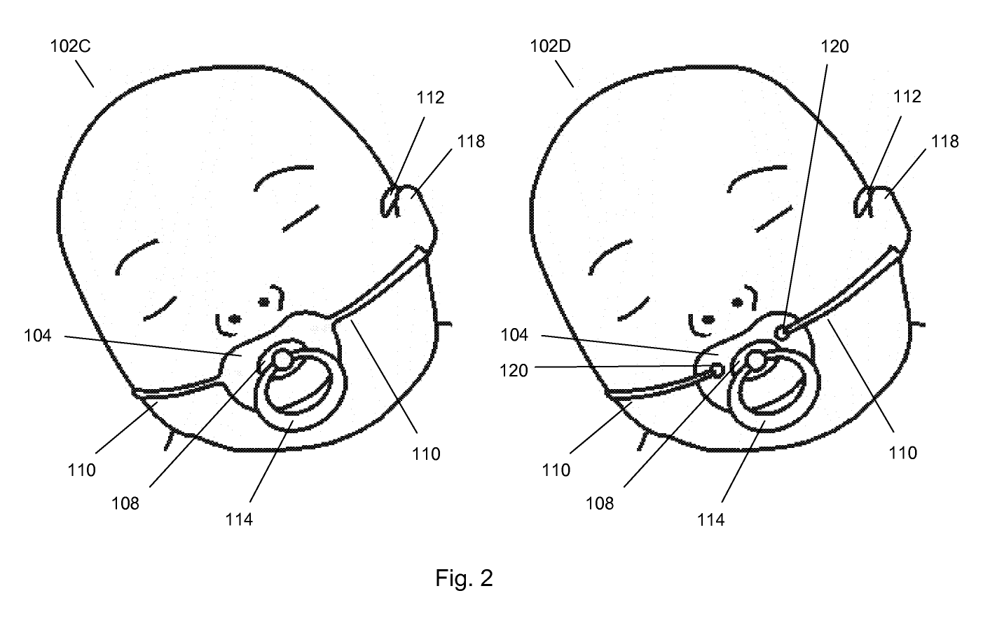

In embodiments, the invention may have an earpiece 112 with resilient side member 110 attached to one or both sides of the platform 104. For example, FIG. 2 shows a child 102C-D with the invention having resilient side members 110 attached to both sides of the platform 104. The parent may choose to have both sides of the child 102C-D accommodated with the invention to better insure the passive securing of the invention to the child 102C-D. Alternatively, the parent may choose to have only one side of the child 102A-B accommodated with the invention to ease the removal of the invention. FIG. 2 also shows two separate embodiments of the invention, one where the invention on the child 102C includes a single side member 110 and platform 104 assembly, and one where the invention on the child 102D includes separate side member 110 and platform 104 assemblies. In addition, other assemblages of the invention may be obvious to one skilled in the art.

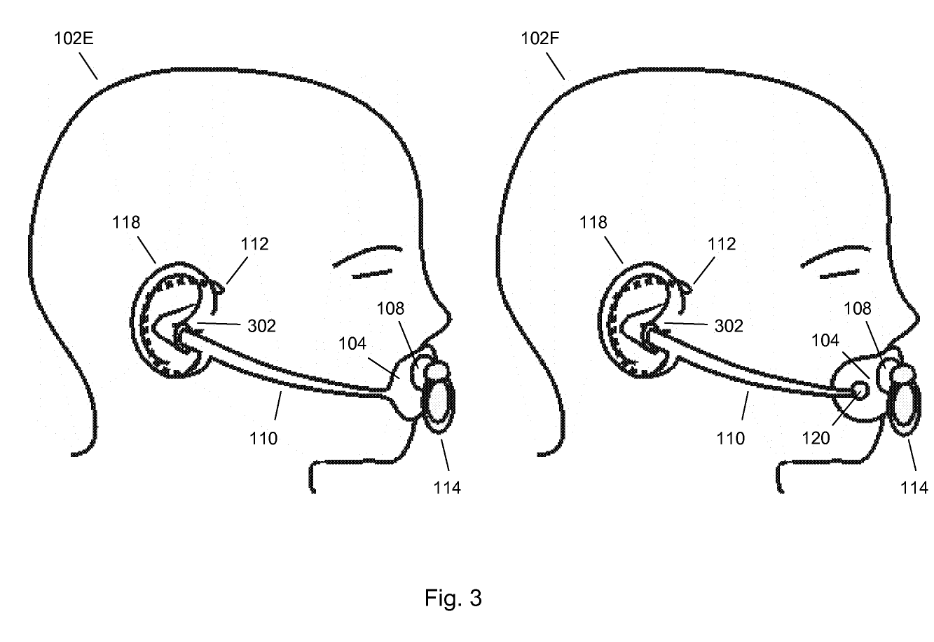

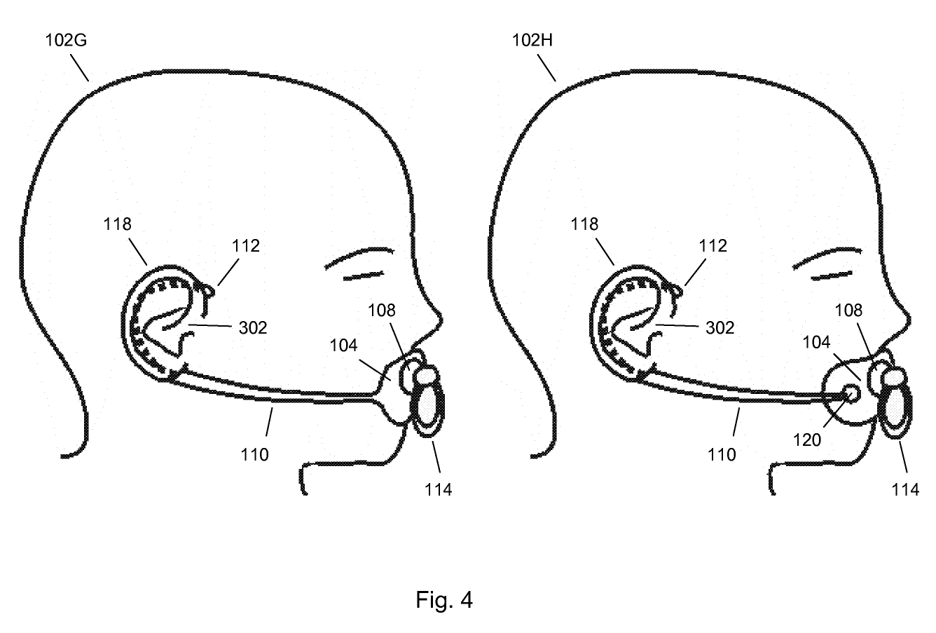

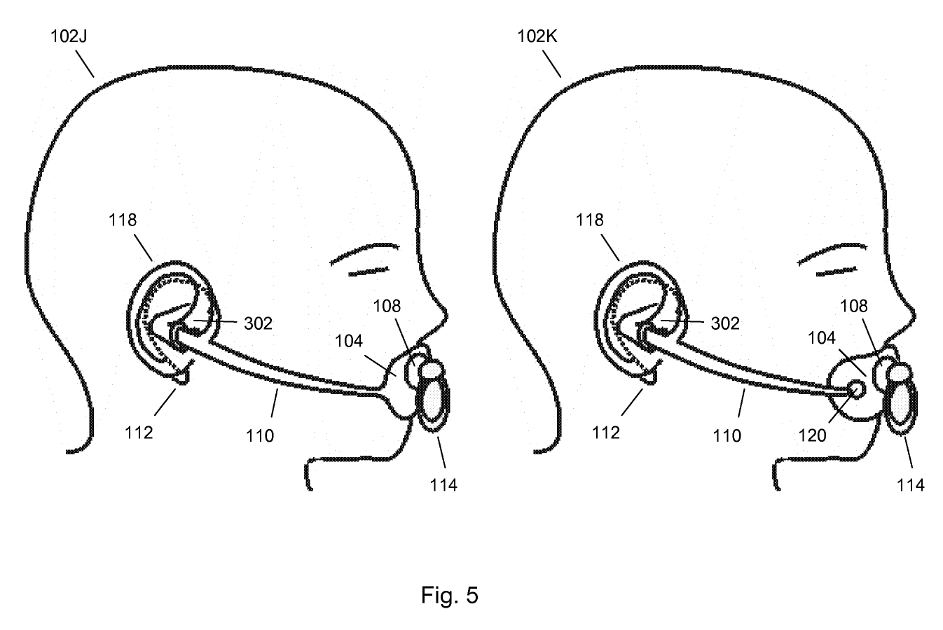

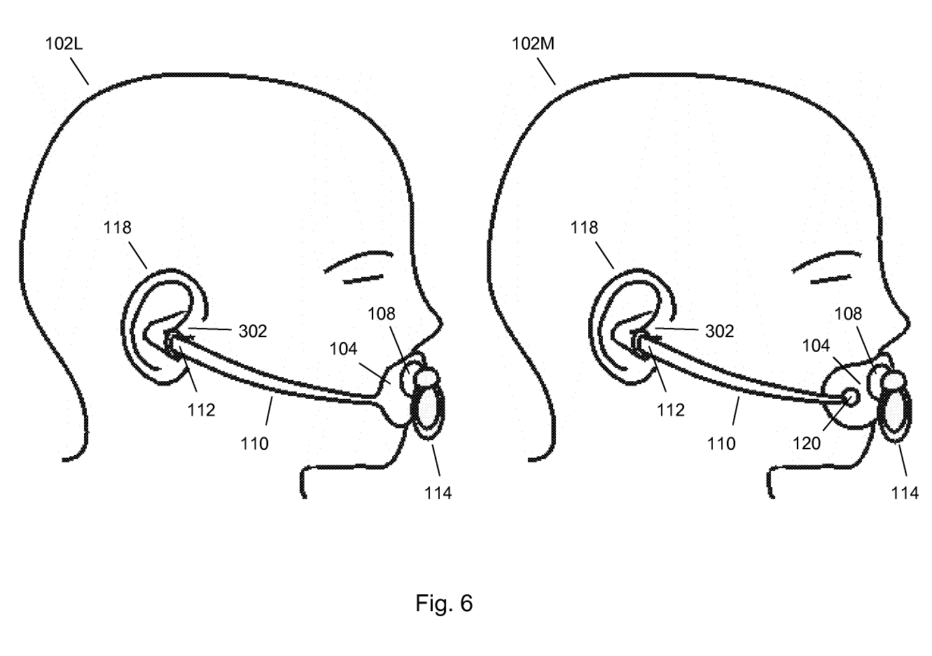

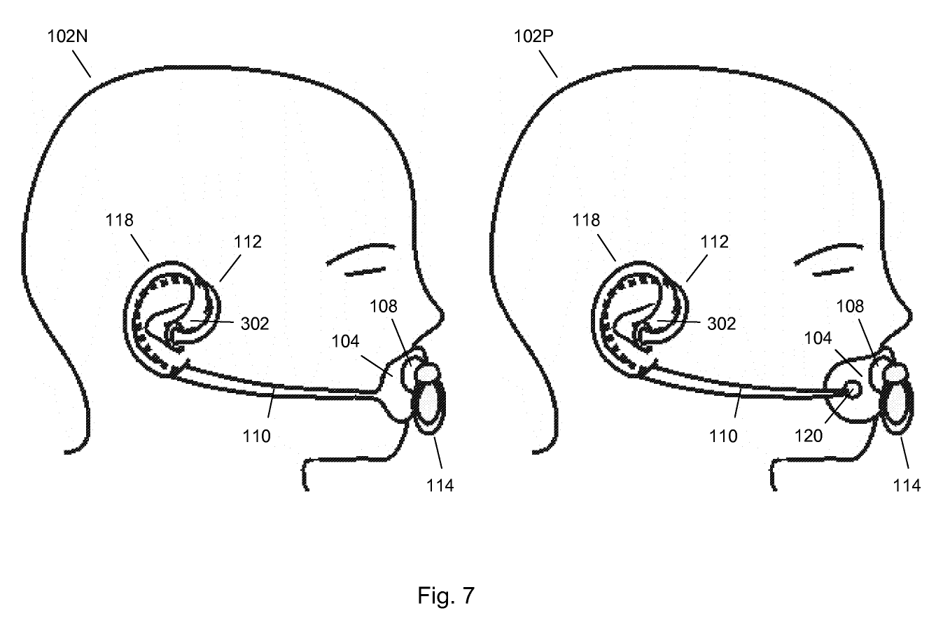

In embodiments, the earpiece 112 may be configurable to adapt to the needs and preferences of the child 102. In embodiments, the earpiece may secure to the area around the ear 118 in a plurality of ways, and may disconnect from the resilient side member 110 to make it easier for the parent to change earpieces 112. FIG. 3 shows a child 102E-F with an earpiece 112 that wraps around the ear 118 from below, as well as into an area in proximity to the ear canal 302. FIG. 4 shows a child 102G-H with an earpiece 112 that only wraps around the ear 118 from below. FIG. 5 shows a child 102J-K with an earpiece 112 that wraps around the ear 118 from above, as well as into an area in proximity to the ear canal 302. FIG. 6 shows a child 102L-M with an earpiece 112 that secures to the ear 118 only in the area of the ear canal 302. FIG. 7 shows a child 102N-P with an earpiece 112 that wraps around the ear 118 from below, and then into the area in proximity of the ear canal 302. FIGS. 3-7 also show two separate embodiments of the invention, one where the invention on the child 102E,G,J,L,N comprises a single side member 110 and platform 104 assembly, and one where the invention on the child 102F,H,K,M,P comprises separate side member 110 and platform 104 assemblies. In addition, other assemblages of the invention may be obvious to one skilled in the art.

In an application of the invention where there is a resilient side member and earpiece on only one side of the child, the child need only push the invention away from their mouth. In an application of the invention where there is a resilient side member and earpiece on both sides of the child, the child need only gently pull one earpiece of an ear, and push the invention away from their mouth. The use of one or two side members may be an option in embodiments of the invention, and one or the other may be selected by the parent as needs vary, such as if a child is to be put to sleep, versus a child being rolled in a stroller, upright and awake.

While the invention has been disclosed in connection with certain preferred embodiments, other embodiments will be recognized by those of ordinary skill in the art, and all such variations, modifications, and substitutions are intended to fall within the scope of this disclosure. Thus, the invention is to be understood with reference to the following claims, which are to be interpreted in the broadest sense allowable by law. All documents referenced herein are hereby incorporated by reference.

1. A pacifier, comprising:
a protrusion adapted to be placed inside an infants mouth;
a platform wherein the protrusion is attached;
a resilient side member, wherein the member is attached to the platform; and
an earpiece attached to the side member, wherein the earpiece is adapted to secure the resilient side member to an infant's ear.

2. The pacifier of claim 1, wherein the resilient side member attachment to the platform forms a flexible attachment.

3. The pacifier of claim 1, wherein the resilient side member attachment to the platform can be disconnected.

4. The pacifier of claim 1, wherein the resilient side member forms a flexible attachment to the platform.

5. The pacifier of claim 1, wherein the platform is substantially resilient.

6. The pacifier of claim 1, wherein the resilient side member and the platform are formed as a single assembly.

7. The pacifier of claim 6, wherein the single assembly is injection molded.

8. The pacifier of claim 1, wherein the earpiece and the resilient side member are formed as a single assembly.

9. The pacifier of claim 1, wherein the earpiece attachment to the side member can be disconnected.

10. The pacifier of claim 1, wherein the earpiece, the resilient side member, and the platform are formed as a single assembly.

11. The pacifier of claim 10, wherein the earpiece is resilient.

12. The pacifier of claim 10, wherein the earpiece is injected molded.

13. The pacifier of claim 10, wherein the earpiece is flexible.

14. The pacifier of claim 10, wherein the earpiece is insulator-coated wire.

15. The pacifier of claim 1, wherein the earpiece is adapted to secure around the outer ear.

16. The pacifier of claim 15, wherein the earpiece is adapted to secure around the top of the outer ear.

17. The pacifier of claim 15, wherein the earpiece is adapted to secure around the bottom of the outer ear.

18. The pacifier of claim 1, wherein the earpiece is adapted to secure in proximity of the ear canal.

19. The pacifier of claim 18, wherein the earpiece is adapted to secure directly outside the ear canal.

20. The pacifier of claim 18, wherein the earpiece is adapted to secure directly inside the ear canal.

21-47. (canceled)
